(19) United States
(12) Patent Application Publication
(10) Pub. No.: US 2016/0009201 A1
(43) Pub. Date: Jan. 14, 2016

(54) RECLINER OF VEHICLE SEAT

(71) Applicant: DAS Co., Ltd., Gyeongsangbuk-do (KR)

(72) Inventors: Ki Hong KIM, Ulsan (KR); Dong Soo KIM, Ulsan (KR)

(73) Assignee: DAS Co., Ltd., Gyeongsangbuk-do (KR)

(21) Appl. No.: 14/770,989

(22) PCT Filed: Oct. 16, 2014
(86) PCT No.: PCT/KR2014/009748

§ 371 Date: Aug. 27, 2015

(30) Foreign Application Priority Data
Oct. 31, 2013 (KR) 10-2013-0131318

(51) Int. Cl. B60N 2/235; B60N 2/22

(52) U.S. Cl. CPC B60N 2/2356; B60N 2/22

(57) ABSTRACT

The present invention relates to a recliner of a vehicle seat, in which an edge of a plate holder is not provided with a guide part receiving a sector tooth, thereby achieving miniaturization and weight reduction of the recliner. Further, a guide ring is fixed by curling and pressing without being welded, such that a welding facility may not be required and an assembling process may be simplified.

### TECHNICAL FIELD

Exemplary embodiments of the present invention relates to a recliner of a vehicle sheet, and more particularly, to a recliner of a vehicle sheet in which a seat cushion of a vehicle seat is installed at a connection portion of a seat back to control and fix an angle of the seat back.

### BACKGROUND ART

A vehicle seat is configured to include a seat cushion on which a passenger is seated, a seat back on which the passenger's back is leaned while in a sitting position, and a headrest on which a passenger's head is leaned.

The seat cushion is configured to be installed at a floor but movable forward and backward, the seat back is configured to be rotatably equipped at a back end of the seat cushion, and the headrest is configured to be a vertical positioning control at an upper end of the seat back.

An apparatus which may control an angle of the seat back and keep the seat back in a fixed state at any position where the angle of the seat back is controlled is a recliner.

The recliner includes a plate holder which is equipped in the seat cushion, a sector tooth which is equipped in the seat back, a pawl tooth which is installed between the plate holder and the sector tooth so that the plate holder guides a behavior of the pawl tooth and is selectively meshed with the sector tooth, a shaft which is installed to penetrate through the plate holder and the sector tooth and is connected to a recliner lever of a side portion of the seat, a cam lever which is installed at the shaft to rotate the pawl tooth at the time of the operation of the recliner lever so as to release the meshed state with the sector tooth, a cam spring which returns the cam lever by an elastic restoring force generated when a user releases his/her grip on a recliner lever so as to again mesh the pawl tooth with the sector tooth, and a guide ring which interconnects between the plate holder and the sector tooth.

Therefore, the pawl tooth is meshed with the sector tooth by an ordinary operation of the cam spring to hold the sector tooth so as to keep the seat back in the fixed state and then when the user pulls the recliner lever, the pawl tooth overcomes the elasticity of the cam spring to rotate and is separated from the sector tooth to freely rotate the sector tooth, thereby controlling the angle of the seat back. Further, the angle of the seat back is controlled and then when the user releases his/her grip on the recliner lever, the pawl tooth is again meshed with the sector tooth by the cam spring, thereby keeping the seat back in the state in which the angle of the seat back is controlled.

The recliner of the vehicle seat operated by the above configuration and operation method is disclosed in Korean Patent Laid-Open Publication No. 10-2011-0135535 (Dec. 19, 2011).

Meanwhile, as illustrated in FIG. 1, the existing recliner has a structure in which an outer circumference surface of a plate holder 1 is provided with a guide part 1a along a circumferential direction thereof, a sector tooth 2 is inserted into and seated on the guide part 1a, a guide ring 7 is equipped on the outer circumferential surfaces of the plate holder 1 and the sector tooth 2 to couple between the plate holder 1 and the sector tooth 2 (non-explained reference numerals 3, 4, and 5 each are a pawl tooth, a cam lever, and a cam spring).

However, a size and a weight of the recliner are increased as much as the guide part 1a (width=I) formed in the plate holder 1, which does not meet the tendency toward miniaturization and weight reduction of a part to improve fuel efficiency of a vehicle.

Accordingly, as illustrated in FIG. 2, the guide part 1a is removed from the plate holder 1 to make an outer diameter of the plate holder 1 equal to that of the sector tooth 2, the guide ring 7 of which the inner circumferential surface is a flat form is applied to perform laser welding on the plate holder 1 and the guide ring 7, and then an end of the guide ring 7 is bent to hold the sector tooth 2 so as to couple between the plate holder 1 and the sector tooth 2.

However, to perform the laser welding, a laser welding facility needs to be prepared. Therefore, operating the laser welding facility may be costly.

Further, the plate holder 1 is thermally deformed (after the plate holder 1 is thermally expanded, the plate holder does not return to an original state) by heat applied at the time of the laser welding and thus a gap is generated between the guide ring 7 and the sector tooth 2, such that an assembled state of the sector tooth 2 is instable and thus the sector tooth may rattle. As a result, the meshing of the pawl tooth 3 is instable and thus the position fixing of the seat back may be instable.

### DISCLOSURE

### Technical Problem

An object of the present invention is to provide a recliner of a vehicle seat capable of reducing a size and a weight of the recliner by removing a guide part from a plate holder and saving costs and more stably fixing a position of a seat back by preventing the occurrence of a gap due to laser welding to prevent a sector tooth from moving.

### Technical Solution

In accordance with one aspect of the present invention, a recliner of a vehicle seat includes: a plate holder configured to be fixed to a seat cushion frame; a sector tooth configured to be fixed to a seat back frame; a pawl tooth configured to be inserted between the plate holder and the sector tooth to be selectively meshed with the sector tooth; a cam lever configured to separate the pawl tooth from the sector tooth at the time of operation a recliner lever; a cam spring configured to have rotate the cam lever to mesh the pawl tooth with the sector tooth when the recliner lever is not operated, the cam spring having one end fixed to the cam lever and another end fixed to the plate holder; and a guide ring configured to couple between the plate holder and the sector tooth while enclosing outer circumferential surfaces of the plate holder and the sector tooth, wherein a middle portion in a vertical direction of the guide ring is provided with a plate holder support end by a one-stage drawing and a lower end thereof is provided with a sector tooth support end by a two-stage drawing.

An upper end of the guide ring may be curled inward and then pressed to fix the plate holder.

A corner in a lower end of the guide ring may be provided with a burr groove at the time of the two-stage drawing of the guide ring.

A guide part enclosing the sector tooth may not be formed at an edge of the plate holder and may be formed flatly.

The plate holder may be formed to have a diameter larger than that of the sector tooth and the plate holder may be locked and supported to a plate holder support end of the guide ring.

The plate holder may have a press-fitted protrusion protruding on the outer circumferential surface thereof.

When the plate holder is press-fitted in the guide ring, an inner circumferential surface of the guide ring may be pressed by the press-fitted protrusion and may be deformed and thus the inner circumferential surface of the guide ring may be provided with a press-fitted groove coupled with the press-fitted protrusion.

### Advantageous Effects

As described above, according to the embodiments of the present invention, the guide part is not formed at an edge of the plate holder and therefore the size and the weight of the plate holder are reduced. Therefore, the size and the weight of the guide ring which is equipped on the outer circumferential surfaces of the plate holder and the sector tooth are also reduced. As a result, it is possible to reduce the size and the weight of the recliner.

Further, the laser welding is not performed on the plate holder and the guide ring and therefore the plate holder is not thermally expanded. Therefore, the gap is not formed between the guide ring and the sector tooth, and as a result it is possible to prevent the sector tooth from moving. As a result, the meshing of the sector tooth with the pawl tooth is stable and thus the rattling of the seat back may be prevented and the angle fixing state of the seat back may be stably kept.

Further, the outer circumferential surface of the plate holder is provided with the press-fitted protrusions. The press-fitted protrusion deforms the inner circumferential surface of the guide ring to form the press-fitted groove so as to couple between the press-fitted protrusion and the press-fitted groove, thereby greatly improving the bonding strength between the plate holder and the guide ring. As a result, it is possible to prevent the guide ring from independently rotating.

As a result, it is possible to improve the assembling strength of the recliner and the operation performance of the recliner.

### DESCRIPTION OF DRAWINGS

FIG. 1 is a partial cross-sectional view of a recliner according to the related art.

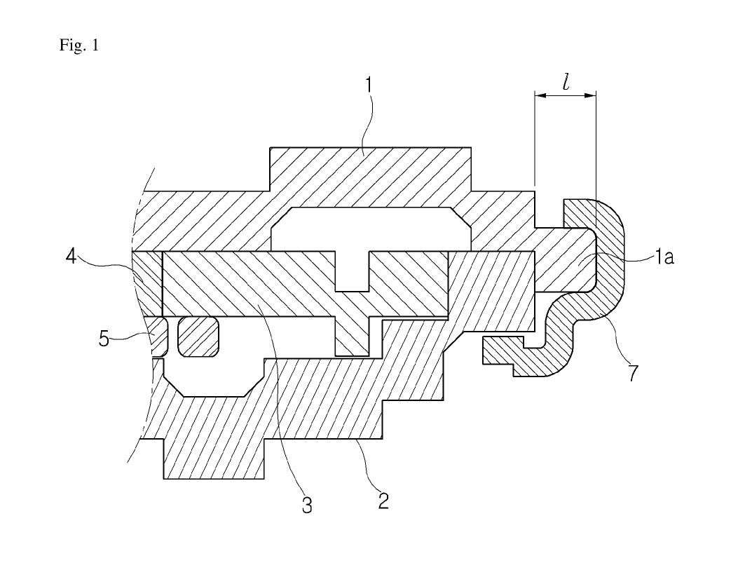

FIG. 2 is a diagram illustrating an embodiment of anther related art.

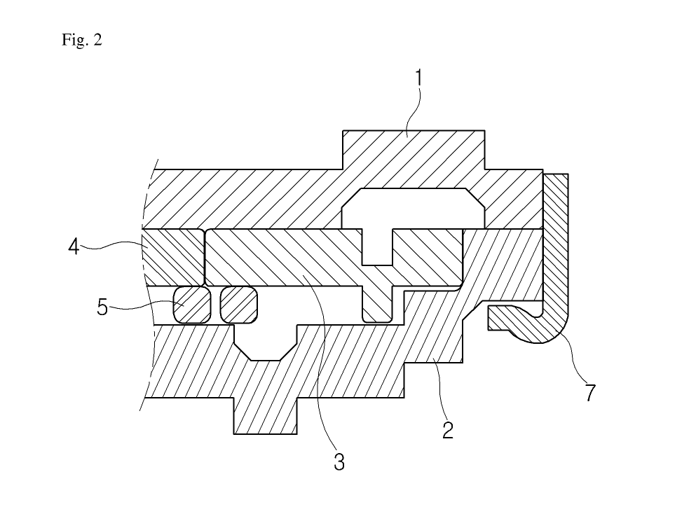

FIG. 3 is an exploded perspective view of a recliner according to an embodiment of the present invention.

FIG. 4 is a cross-sectional view of an assembled state of the recliner according to an embodiment of the present invention.

FIG. 5 is a comparative view of a plate holder, in which FIG. 5A is a perspective view of a plate holder according to the related art and FIG. 5B is a perspective view of a plate holder according to an embodiment of the present invention.

FIG. 6 is a cross-sectional view illustrating a state of a guide ring before the guide ring is assembled, as one configuration of the present invention.

FIG. 7 is a partially enlarged perspective view of a plate holder according to the embodiment of the present invention.

FIG. 8 is a perspective view of a state of the plate holder according to the embodiment of the present invention just before the plate holder is coupled with a sector tooth and a guide ring.

FIG. 9 is a partially enlarged cross-sectional view of a state in which the plate holder is press-fitted in the guide ring in the state of FIG. 8.

### BEST MODE

The present invention may be modified in various ways and implemented by various exemplary embodiments, so that specific exemplary embodiments are shown in the drawings and will be described in detail. However, it is to be understood that the present invention is not limited to a specific exemplary embodiment, but includes all modifications, equivalents, and substitutions without departing from the scope and spirit of the present invention. In the present description, thicknesses of lines, sizes of components, or the like, illustrated in the accompanying drawings may be exaggerated for clarity and convenience of explanation.

Further, the following terminologies are defined in consideration of the functions in the present invention and may be construed in different ways by the intention or practice of users and operators. Therefore, the definitions of terms used in the present description should be construed based on the contents throughout the specification.

Hereinafter, exemplary embodiments of the present invention will be described in detail with reference to the accompanying drawings.

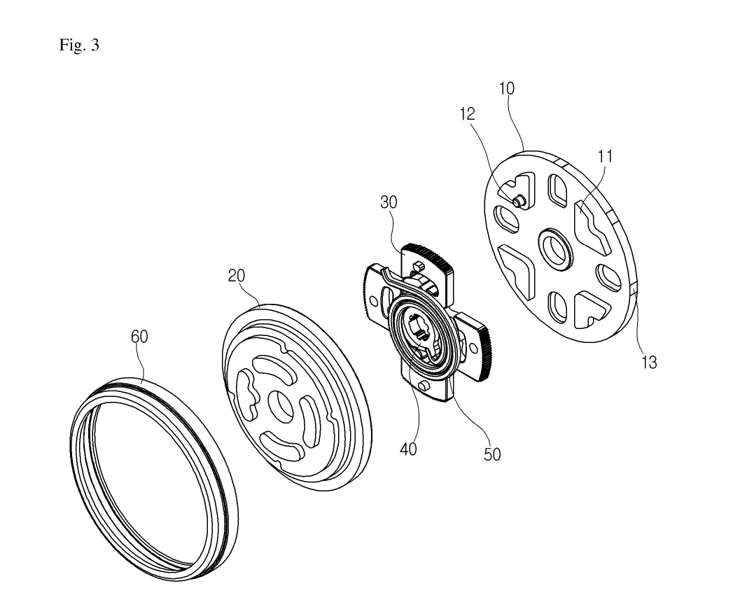

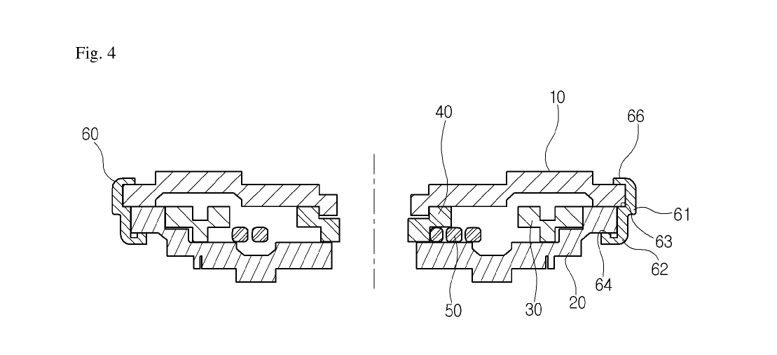

As illustrated in FIGS. 3 and 4, a recliner of a vehicle seat according to an embodiment of the present invention has a structure in which a plate holder 10 and a sector tooth 20 are formed of a disk shape, the plate holder 10 comes into contact with the sector tooth 20 in a state in which the pawl tooth 30, the cam lever 40, and the cam spring 50 are interposed between the plate holder 10 and the sector tooth 20, and an outer circumferential surface of the sector tooth 20 is provided with a guide ring 60.

The plate holder 10 is fixed to a seat cushion frame and the sector tooth 20 may be fixed to a seat back frame.

Although not illustrated, an inner circumferential surface of an edge of the sector tooth 20 is provided with a tooth form meshed with a tooth form of the pawl tooth 30.

The pawl tooth 30 may radially move between guide protrusions 11 of the plate holder 10 and the cam lever 40 is connected to a recliner lever which is operated by a passenger through a shaft (not illustrated).

One end of the cam spring 50 is locked to the cam lever 40 and the other end thereof is locked to a locking protrusion 12 of the plate holder 10, and thus the cam lever 40 keeps a rotating state so as to push the pawl tooth 30 toward a radial outside.

Therefore, the cam lever 40 usually rotates by the cam spring 50 to push the pawl tooth 30 to the radial outside so that the pawl tooth 30 is meshed with the sector tooth 20, thereby keeping the seat back in the fixed state. When a passenger operates the recliner lever to rotate the cam lever 40 reversely, the pawl tooth 30 moves to a radial inside to be released from the sector tooth 20, thereby freely controlling the angle of the seat back.

As illustrated in FIGS. 3 to 5, the plate holder 10 according to the embodiment of the present invention has a disk shape and an edge of an outer side of the plate holder 10 is not provided with a guide part in which the sector tooth 20 is received.

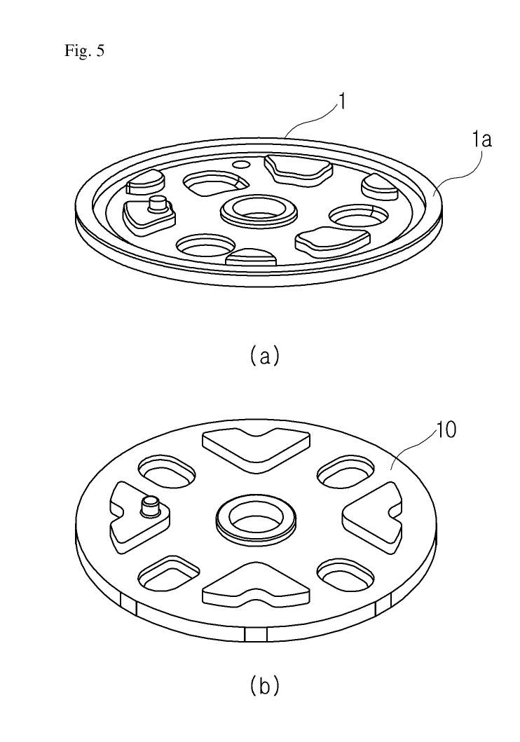

That is, the edge of the plate holder 10 is not provided with a stepped guide part which encloses the edge of the sector tooth 20. This may be more apparent from the comparison of the case in which the edge of the existing plate holder 1 illustrated in FIG. 5A is provided with the stepped guide part 1a with the case in which the edge of the plate holder 10 according to the embodiment of the present invention illustrated in FIG. 5B is not provided with the stepped guide part.

However, as illustrated in FIG. 4, the recliner according to the embodiment of the present invention is configured so that an outer diameter of the plate holder 10 is larger than that of the sector tooth 20 and thus a step is formed at the edge when the plate holder 10 comes into contact with the sector tooth 20. A difference between the outer diameters of the plate holder 10 and the sector tooth 20 is insignificant as about 1 to 1.5 mm and is enough to have the plate holder 10 locked to a plate holder support step 63 of the guide ring 60 to be described below.

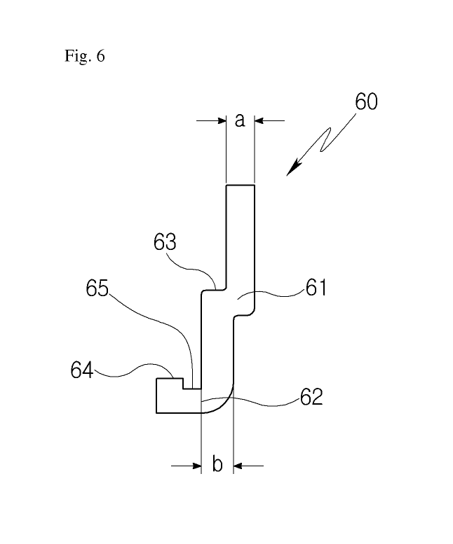

As illustrated in FIG. 6, a middle portion in a width direction (vertical direction in the drawing) of the guide ring 60 is also provided with a step, corresponding to the stepped shape.

The guide ring 60 is manufactured by a two-step drawing process. First, a lower portion of an inner diameter portion of a material having a ring shape goes through a one-step drawing to form a one-stage molding part 61 and then a lower portion of an inner diameter portion of the one-stage molding part 61 again goes through a two-step drawing to form a two-stage molding part 62.

At the time of molding the one-stage molding part 61, a middle portion of an inner circumferential surface of the guide ring 60 is provided with a step, that is, the plate holder support step 63 and at the time of molding the two-stage molding part 62, a lower end protrudes toward an inner diameter and thus a sector tooth support step 64 supporting the sector tooth 20 is formed, and at the same time a burr groove 95 depressed downwardly is also formed inside the sector tooth support step 64.

In this case, a thickness of an upper portion of the one-stage molding part 61 is 1.4 t and a thickness b of a lower portion thereof is 1.6 t. As such, the thickness of the lower portion of the one-stage molding part 61 is slightly thicker than that of the upper portion thereof to reinforce the stiffness and the thickness of the upper portion of the one-stage molding part 61 is slightly thinner than that of the lower portion thereof to facilitate curling and pressing processes which will be described below.

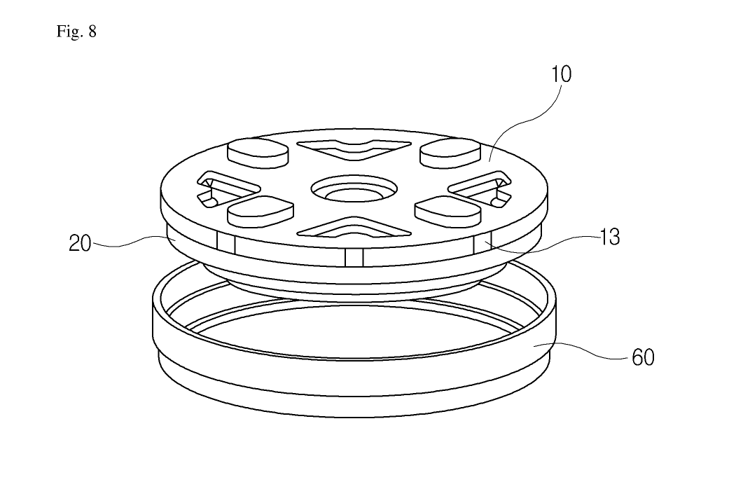

In the state molded as illustrated in FIG. 6, the sector tooth 20 and the plate holder 10 are inserted downward from the top (see FIG. 8). The pawl tooth 30, the cam lever 40, and the cam spring 50 are inserted between the sector tooth 20 and the plate holder 10 (see FIG. 8).

As described above, when the sector tooth 20 and the plate holder 10 are inserted into the guide ring 60, the sector tooth 20 is supported to the sector tooth support step 64 and the plate holder 10 is supported to the plate holder support step 63.

Next, an upper end 66 of the guide ring 60 is curled inward to be pressed (The curling is a molding method of rolling an end. Therefore, the present invention performs the molding in such a manner that the upper end 66 of the guide ring 60 is not completely curled but is curled about half and is then pressed horizontally).

As described above, the assembling of the plate holder 10 and the sector tooth 20 is completed inside the guide ring 60.

As described above, curling and pressing the upper end 66 of the guide ring 60 generate insignificant heat as compared with the laser welding, and therefore the thermal expansion of the plate holder 10 is not caused, such that the occurrence of the gap between the guide ring 60 and the sector tooth 20 due to the thermal expansion of the plate holder 10 is prevented.

Therefore, the sector tooth 20 may rotate in the guide ring 60 and does not move radially. Further, the sector tooth 20 does not behave in a shaft direction while adhering to the plate holder 10 and therefore may move only in a direction (circumferential direction) to be behaved. The behavior of the sector tooth 20 in other directions is limited and therefore the sector tooth 20 does not rattle, such that the meshing of the sector tooth 20 with the pawl tooth 30 is certainly made and the meshed state therebetween is firmly kept, thereby stably keeping the angle control state of the seat back.

Further, the press fitting is made when the plate holder 10 is inserted into the guide ring 60. That is, the plate holder 10 is press-fitted in the inner diameter of the guide ring 60 and thus the guide ring 60 and the plate holder 10 may be firmly coupled with each other.

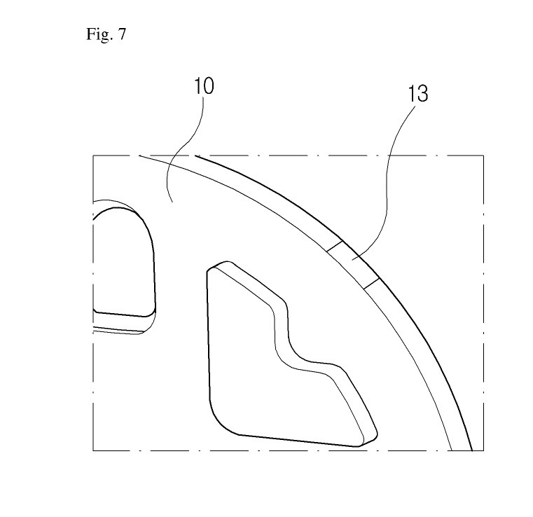

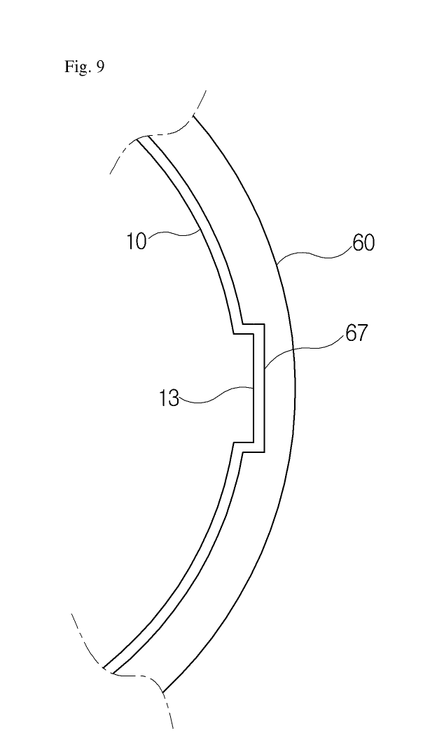

Further, as illustrated in FIGS. 7 and 8, the outer circumferential surface of the plate holder 10 may be provided with the plurality of press-fitted protrusions 13 at equidistance. The protruded degree of the press-fitted protrusion 13 is about 0.05 mm but when the plate holder 10 is press-fitted in the guide ring 60, as illustrated in FIG. 9, the inner circumferential surface of the guide ring 60 is provided with a press-fitted groove 67 by the press-fitted protrusion 13.

That is, the press-fitted protrusion 13 is advanced while strongly compressing the inner circumferential surface of the guide ring 60 and thus the inner circumferential surface of the guide ring 60 is deformed by the pressing to form the press-fitted groove 67, such that the press-fitted protrusion 13 is inserted into and locked to the press-fitted groove 67.

Therefore, the plate holder 10 and the guide ring 60 is more firmly assembled, and thus the assembling stability of the sector tooth 20 received in the guide ring 60 and other parts may be improved and the phenomenon that the guide ring 60 itself runs idle alone may be prevented.

Meanwhile, a burr groove 65 formed at a corner of the lower end of the guide ring 60 is a space receiving a burr formed at the time of machining the sector tooth 20. When the burr groove 65 is not formed, a separate post-process for removing the burr is required.

As described above, according to the embodiment of the present invention, the guide part is not formed in the plate holder, such that the miniaturization and the weight reduction of the recliner may be achieved and the plate holder may be easily manufactured.

The laser welding is not used and therefore the gap between the guide ring and the sector tooth due to the thermal expansion of the plate holder does not occur, such that the rattling of the sector tooth due to the radial movement of the sector tooth may be prevented.

The locking jaw is formed at the middle portion of the guide ring and thus the guide ring and the plate holder may be firmly coupled with each other.

The assembling is completed by the curling and the pressing of the upper end of the guide ring instead of the laser welding, such that the process is simple and the facility preparing and operating cost may be saved.

The outer circumferential surface of the plate holder is provided with the press-fitted protrusion and the press-fitted protrusion is press-fitted in the inner circumferential surface of the guide ring to form the press-fitted groove, such that the plate holder is coupled with the guide ring, thereby more firmly coupling between the plate holder and the guide ring, in particular, between the plate holder and the guide ring in the circumferential direction.

Although the embodiments of the present invention have been described in detail as described above, they are only examples. It will be appreciated by those skilled in the art that various modifications and equivalent other embodiments are possible from the present invention. Therefore, the scope of the present invention is to be defined by the following claims.

1. A recliner of a vehicle seat, comprising:
a plate holder configured to be fixed to a seat cushion frame;
a sector tooth configured to be fixed to a seat back frame;
a pawl tooth configured to be inserted between the plate holder and the sector tooth to be selectively meshed with the sector tooth;
a cam lever configured to separate the pawl tooth from the sector tooth at the time of operation a recliner lever;
a cam spring configured to rotate the cam lever to mesh the pawl tooth with the sector tooth when the recliner lever is not operated, the cam spring having one end fixed to the cam lever and another end fixed to the plate holder; and
a guide ring configured to couple between the plate holder and the sector tooth while enclosing outer circumferential surfaces of the plate holder and the sector tooth,
wherein a middle portion in a vertical direction of the guide ring is provided with a plate holder support end by a one-stage drawing and a lower end thereof is provided with a sector tooth support end by a two-stage drawing.

2. The recliner of a vehicle seat of claim 1, wherein an upper end of the guide ring is curled inward and then pressed to fix the plate holder.

3. The recliner of a vehicle seat of claim 1, wherein a corner in a lower end of the guide ring is provided with a burr groove at the time of the two-stage drawing of the guide ring.

4. The recliner of a vehicle seat of claim 1, wherein a guide part enclosing the sector tooth is not formed at an edge of the plate holder and is formed flatly.

5. The recliner of a vehicle seat of claim 1, wherein the plate holder is formed to have a diameter larger than that of the sector tooth and the plate holder is locked and supported to a plate holder support end of the guide ring.

6. The recliner of a vehicle seat of claim 1, wherein the plate holder has a press-fitted protrusion protruding on the outer circumferential surface thereof.

7. The recliner of a vehicle seat of claim 6, wherein when the plate holder is press-fitted in the guide ring, an inner circumferential surface of the guide ring is pressed by the press-fitted protrusion and is deformed and thus the inner circumferential surface of the guide ring is provided with a press-fitted groove coupled with the press-fitted protrusion.
